(19) United States
(12) Patent Application Publication
(10) Pub. No.: US 2022/0018484 A1
(43) Pub. Date: Jan. 20, 2022

(54) SYSTEMS AND METHODS FOR TRAVEL DISTANCE MEASUREMENT

(71) Applicant: OLYMPUS CORPORATION, Tokyo (JP)

(72) Inventors: Tao Zhang, San Diego, CA (US); Lichung Chu, San Diego, CA (US); Shinhaeng Lee, San Diego, CA (US); Hiroyuki Fukuda, San Diego, CA (US)

(21) Appl. No.: 17/488,009

(22) Filed: Sep. 28, 2021

Related U.S. Application Data
(63) Continuation of application No. PCT/IB2019/000462, filed on Mar. 28, 2019.

(51) Int. Cl. F16L 55/48; G01C 21/16

(52) U.S. Cl. CPC F16L 55/48; G01N 29/225; G01C 21/165

(57) ABSTRACT

Systems and methods for determining positioning of a scanner moving along a section of a pipe, may include: an encoder and a counter measuring distance traveled by the scanner along a plurality of scan lines along a length of the section of the pipe; measuring acceleration and angular velocity of the scanner around a portion of the circumference of the pipe between successive scan lines; computing an angle of rotation of the scanner around the portion of the circumference of the pipe between successive scan lines, and determining a distance traveled around the portion of the circumference of the pipe between first and second scan lines using the computed angle of rotation. The process may further include determining a position of the device using the distance traveled measurements from the counter and the fusion circuit.

### REFERENCE TO RELATED APPLICATION

The present application is a continuation of and claims priority to International Application No. PCT/IB2019/000462, filed Mar. 28, 2019 and titled “SYSTEMS AND METHODS FOR TRAVEL DISTANCE MEASUREMENT,” which is incorporated herein by reference in its entirety.

### TECHNICAL FIELD

The disclosed technology relates generally to object tracking and travel distance measurement systems and methods.

### DESCRIPTION OF THE RELATED ART

The Global Non-Destructive Testing (NDT) Equipment Market has grown dramatically, at a CAGR of 8.1% in the forecast period 2017 to 2024. In NDT equipment, ultrasonic technology dominates the market. Other technologies include Radiography, Eddy current measurements and others.

Most of the NDT devices available today have to be in direct contact with the specimen. To specify the location of the defect or guarantee proper inspection coverage on the specimen (e.g., a pipe), advanced NDT applications generally require some sort of probe positioning ability. Current probe positioning products primarily offer one-line scanning with position measurements made solely through mechanical scanners or encoders.

Industrial NDT equipment suppliers cater to a large variety of part geometries and materials. But, scanning solutions in the market today are very specific to an application or part geometry and are generally only applicable to relatively simple geometries.

Existing scanning solutions do not offer inspection possibilities for large area scanning or for complex geometries. These scanning solutions are also not flexible to a variety of different specimen geometries. Currently there is no 2-D mapping technology available for scanning pipe elbows, for example, that provides a positioning system that allows the inspector to map the measurements to the specimen.

Although an increasing number of companies are providing volumetric positioning products, such products are either not customized for industrial use (i.e., generally more suitable for consumer business and vehicle industry), or are very expensive due to the high development cost and low volume.

### BRIEF SUMMARY OF EMBODIMENTS

Embodiments provide distance and position estimation for a probe, measurement tool or other scanner moving on the surface of an item to be inspected such as, for example, an oil or gas pipe. Embodiments may include an inertial measurement unit (IMU) for a number of applications, including applications for small working areas. Embodiments may achieve 6-dimensional volumetric positioning, including 3 degrees of XYZ information and 3 degrees of attitude information and may use a fusion algorithm to process this information, which may be gathered using accelerometer and a gyroscope. The 6-dimensional tracking problem can be sent to fight into a one-dimensional solution so that only one-dimensional angle need to be measured. Centripetal acceleration and tangential acceleration may also be considered in the algorithm.

According to various embodiments of the disclosed technology a positioning device for a scanner may include: an encoder coupled to detect movement the scanner along scan lines parallel to a first axis of an object being scanned; a counter configured to count encoder pulses from the encoder and configured to compute distance traveled by the scanner along a first scan line; an inertial measurement unit comprising a 3-axis accelerometer and a gyroscope; and a fusion circuit configured receive acceleration and angular velocity from the 3-axis accelerometer and gyroscope, respectively, use the received acceleration and angular velocity to compute an angle of rotation of the scanner along a second axis of the object being scanned that is perpendicular to the first axis, and to use the computed angle of rotation to determine a distance traveled along the second axis between first and second scan lines. The encoder may be an optical or magnetic encoder.

The positioning device may further include a processor determining a position of the device using the distance traveled measurements from the counter and the fusion circuit. The positioning device may further include a processor to correlate scanner position measured using information from the counter and the fusion circuit with scan data obtained by the scanner during scanning. The processor may be part of the fusion circuit or may be communicatively coupled to the fusion circuit.

The scanner may be operated and scan data correlated to the measured position without requiring that scan lines be marked on a section of a pipe being scanned by the scanner.

Computing the angle of rotation may include removing the mean values from the acceleration and angular velocity measurements and computing a covariance value of acceleration and angular velocity data. The process may apply an extended Kalman filter or unscented filter for a state-space model. The positioning device may further estimate noise and computing a covariance value may include computing a covariance value of acceleration and angular velocity data as a covariance matrix of noise. Computing an angle of rotation of the scanner may include calculating an initial attitude of the accelerometer using the radius of the section of pipe being scanned by the scanner. Calculating an initial attitude may include determining an initial elevation angle, Ø, and an initial circumferential angle, θ₀, using accelerometer readings as follows:

$$\begin{matrix}{θ}_{0} = atan ( \frac{{a}_{0}}{{b}_{0}} ) & ( 1 ) \\ and & \\ ∅ = \frac{π}{2} - atan ( \frac{{c}_{0}}{\sqrt{{a}_{0}^{2} + {b}_{0}^{2}}} ) & ( 2 )\end{matrix}$$

where (a₀ b₀ c₀)^{T} is the accelerometer reading when the scanner is located at the end of the most recently measured scan line along the length of the section of the pipe.

A state vector of the fusion algorithm may be x=(θ, ω, \dot{ω})^{T}, where \dot{ω} is the change of the rate of angular speed along the direction of ω. The fusion algorithm may apply a transformation matrix:

$$A = [ \begin{matrix}1 & dt & 0.5 {dt}^{2} \\ 0 & 1 & dt \\ 0 & 0 & 1\end{matrix} ]$$

The gyroscope and accelerometer measurements may be performed as

$${\tilde{w}}_{x , k} = {ω}_{k} + {n}_{e , ω}$$

$${\tilde{a}}_{k} = {h}_{∅} ( {θ}_{k} ) + [ \begin{matrix}- \dot{ω} r \\ {ω}^{2} r \\ 0\end{matrix} ] + {n}_{e , a}$$

where, r is the radius of pipe, \tilde{w}_{x,k} is a scale value of gyroscope reading for rotation about the first axis, ãₖ is 3×1 vector for accelerometer reading on the first axis, second axis perpendicular to the first axis, and a third axis perpendicular to the first and second axes.

In a further embodiment, a method for determining positioning of a scanner moving along a section of a pipe may include: an encoder and a counter measuring distance traveled by the scanner along a plurality of scan lines along a length of the section of the pipe; measuring acceleration and angular velocity of the scanner around a portion of the circumference of the pipe between successive scan lines; computing an angle of rotation of the scanner around the portion of the circumference of the pipe between successive scan lines, and determining a distance traveled around the portion of the circumference of the pipe between first and second scan lines using the computed angle of rotation. Computing the angle of rotation may include removing the mean values from the acceleration and angular velocity measurements and computing a covariance value of acceleration and angular velocity data. The method may further include determining a position of the device using the distance traveled measurements from the counter and the fusion circuit.

The method may further include estimating noise and computing a covariance value may include computing a covariance value of acceleration and angular velocity data as a covariance matrix of noise. The method of may further include calibrating the accelerometer and gyroscope. Computing and angle of rotation of the scanner comprises calculating an initial attitude of the accelerometer using the radius of the section of pipe being scanned by the scanner.

Calculating an initial attitude may include determining an initial elevation angle, Ø, and an initial angle, θ₀, using accelerometer readings as follows:

$${θ}_{0} = atan ( \frac{{a}_{0}}{{b}_{0}} )$$

$$and$$

$$∅ = \frac{π}{2} - atan ( \frac{{c}_{0}}{\sqrt{{a}_{0}^{2} + {b}_{0}^{2}}} )$$

where (a₀ b₀ c₀)^{T} is the accelerometer reading when the scanner is located at the end of the most recently measured scan line along the length of the section of the pipe.

A state vector of a fusion algorithm used for measurement is x=(θ, ω, \dot{ω})^{T}, where \dot{ω} is the change of the rate of angular speed along the direction of ω.

Determining the distance traveled around the portion of the circumference of the pipe may include applying a transformation matrix:

$$A = [ \begin{matrix}1 & dt & 0.5 {dt}^{2} \\ 0 & 1 & dt \\ 0 & 0 & 1\end{matrix} ]$$

Angular velocity and acceleration measurements may be performed as

$${\tilde{w}}_{x , k} = {ω}_{k} + {n}_{e , ω}$$

$${\tilde{a}}_{k} = {h}_{∅} ( {θ}_{k} ) + [ \begin{matrix}- \dot{ω} r \\ {ω}^{2} r \\ 0\end{matrix} ] + {n}_{e , a}$$

where, r is the radius of pipe, \tilde{w}_{x,k} is a scale value of the angular velocity measurement for rotation about the first axis, ãₖ is 3×1 vector for the acceleration measurement on the first axis, second axis perpendicular to the first axis, and a third axis perpendicular to the first and second axes.

A positioning device for a scanner may include: means for detecting movement the scanner along scan lines parallel to a first axis of an object being scanned; means for counting encoder pulses from the encoder and configured to compute distance traveled by the scanner along a first scan line; means for measuring acceleration and angular velocity of the scanner; and means for computing an angle of rotation of the scanner along a second axis of the object being scanned that is perpendicular to the first axis using the received acceleration and angular velocity, and for determining a distance traveled along the second axis between first and second scan lines using the computed angle of rotation. The scanner may be operated and scan data correlated to the measured position without requiring that scan lines be marked on a section of a pipe being scanned by the scanner.

The means for detecting movement may include an optical or magnetic encoder. The positioning device may further include determining a position of the device using the distance traveled measurements from the counter and the fusion circuit.

The positioning device may further include a means for correlating scanner position measured by the encoder and the fusion circuit with scan data obtained by the scanner during scanning. The means for correlating may be part of the fusion circuit or may be communicatively coupled to the fusion circuit.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates computation of movement about the circumference of a circle, which can be equated to movement around the circumference of a pipe being scanned.

FIG. 2 illustrates an example of an accelerometer in a vertical position.

FIG. 3 is a diagram illustrating an example implementation of a probe including a mechanical encoder and an IMU with a fusion engine in accordance with one embodiment.

FIG. 4 illustrates an example of an operational scenario for a probe including an encoder and an IMU in accordance with various embodiments.

FIG. 5 illustrate an example process for preparing the pipe for measurement and conducting the measurements in accordance with various embodiments.

FIG. 6 illustrates a timing diagram for testing operations in accordance with one embodiment.

FIG. 7 illustrates a process for position determination according to various embodiments.

FIG. 8 illustrates an example of a geometry used to measure an angle of IMU rotation through a Y-section in one embodiment.

FIG. 9 illustrates centripetal acceleration and tangential acceleration.

FIG. 10 illustrates an example of the impact of DC bias and scale factor error.

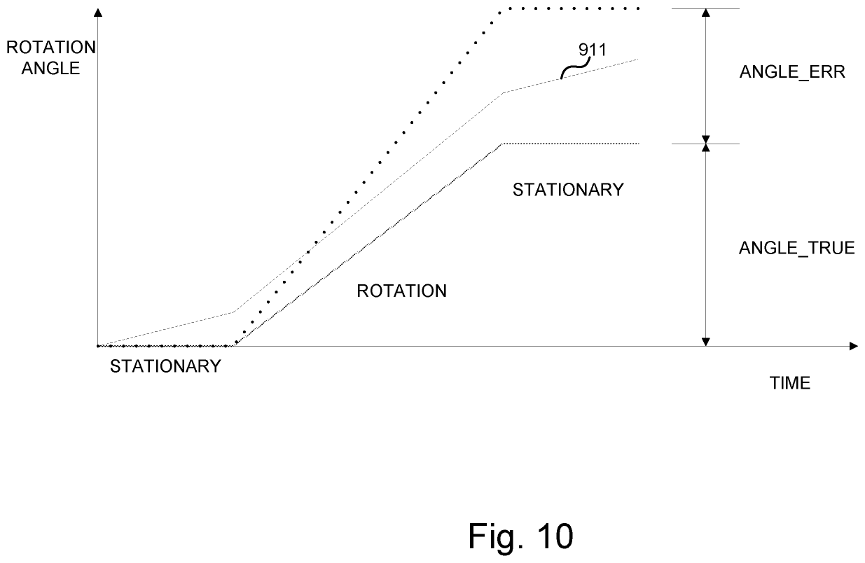

The figures are not intended to be exhaustive or to limit the invention to the precise form disclosed. It should be understood that the disclosed embodiments can be practiced with modification and alteration, and that the disclosed embodiments be limited only by the claims and the equivalents thereof.

### DETAILED DESCRIPTION OF THE EMBODIMENTS

Embodiments of the technology disclosed herein are directed toward devices and methods for measuring travel distances of objects, such as without using a position encoder. Various embodiments of the technology disclosed herein relate to travel distance measurement using sensors such as, for example, an accelerometer and gyroscope, coupled with a fusion circuit including a fusion algorithm to compute distance without an encoder.

An inertial measurement unit (IMU) is an electronic device that measures a body's force and angular rate, and may use a combination of accelerometers and gyroscopes to make the measurements. Measurements can be made, recorded and reported to a user or other systems. Conventional IMUs are typically used to detect the distance, orientation or speed of a body for large-scale applications. For instance, IMUs may be provided on a car, airplane or satellite for navigation. Embodiments herein include IMU technology for a much smaller scale working scenario and combine the IMU technology with a fusion algorithm to achieve Y-axis positioning.

Applications of the probe perform raster scanning on a pipe (either straight pipe or elbow section) or other element. The trajectory of movements during a normal measurement may include several long scan lines in which the probe is moved along the X-axis is along the length of pipe. After finishing each scan line, the probe moves in the Y-axis in the direction perpendicular to the length of the pipe to the next scan line. The ultrasonic detection features of the probe may be activated when probe moving on the X-axis and deactivated when the probe is moving along the Y-axis. The distance between 2 scan lines (X-axis lines) may be established based on the width of ultrasonic detection (normally a phased array). For example, scan line separation is ideally no greater than the scan width of the scanner, and can be slightly smaller to ensure coverage, albeit with some overlap.

To determine the travel distance of the probe, embodiments combine a mechanical encoder for measurements in the X-direction, and an IMU (accelerometer and gyroscope) which may be implemented using MEMS technology to maintain a small package size. The mechanical encoder provides 1-D distance measurement along a scan line (X-axis), and the IMU provides distance measurement for scanner's movement from one scan line to the other (along the Y-axis).

Embodiments may achieve 6-Dimensional volumetric positioning (i.e., including 3 degrees of XYZ information and 3 degrees of attitude information) of a scanner (e.g., an NTD pipe scanner) using an IMU combined with additional novel technology. For example, a fusion algorithm may be included to process the output from the IMU gyroscope and accelerometer. To simplify the algorithm and improve accuracy, the system may be configured to convert the 6-Dimensional tracking problem into a 1-Dimensional tracking problem (measure 1D angle only) by leveraging knowledge of a transverse section of a pipe to be measured (e.g., assuming a perfect circle) and the known radius of the circle. To further improve the accuracy, centripetal acceleration and tangential acceleration may be considered in the algorithm as well. For covering the 2D area of pipe, the X-axis distance is measured by a mechanical encoder and the Y-axis is measured using the IMU and the fusion algorithm. Embodiments of the IMU data processing (fusion) solutions employ a state-space model. Based on this model, a standard extended Kalman filter, unscented Kalman filter or particle filter can be used. Fine calibration of gyroscope may also be important to achieving accurate results.

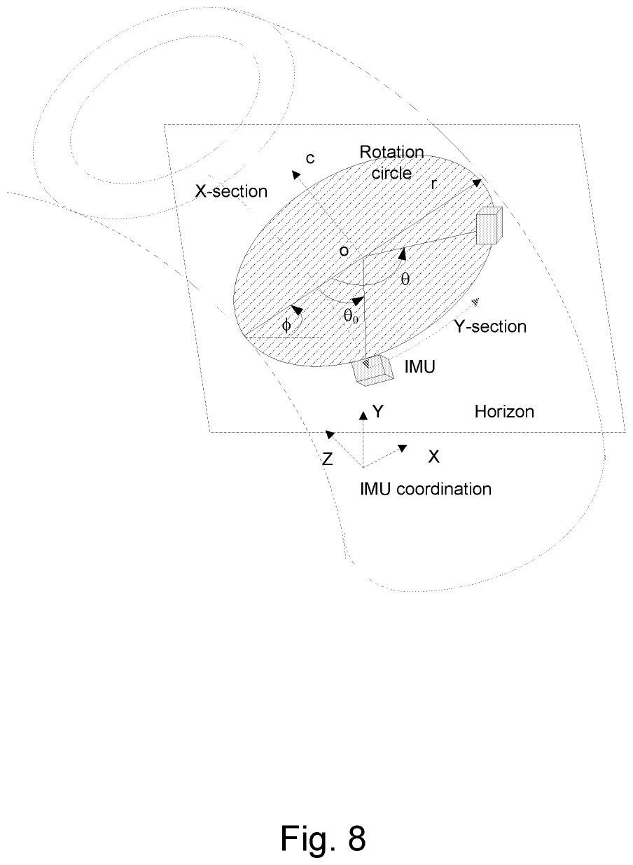

To apply the technology, the NDT probe, scanner or other object is configured to move along the direction of the X-axis of pipe (i.e., longitudinally) or the Y-axis of pipe. The more exact the movement, the better the results. The IMU may be mounted on a probe, scanner or other object, such that its axis, along with X-axis and Y-axis of pipe, when the probe is moving on the pipe. For example, assume the cross section of pipe is a circle. Each Y-axis movement of probe is actually a part of the circle. Without loss of generality, the IMU is mounted on the probe with its defined X-axis aligning with the tangential direction of the circle, its Y-axis pointing to the center of the circle, and its Z-axis along the X-axis of pipe, which is perpendicular to the trajectory circle, as shown in FIG. 8, below. Also, during the measurements, in various embodiments the probe should be kept in touch with pipe.

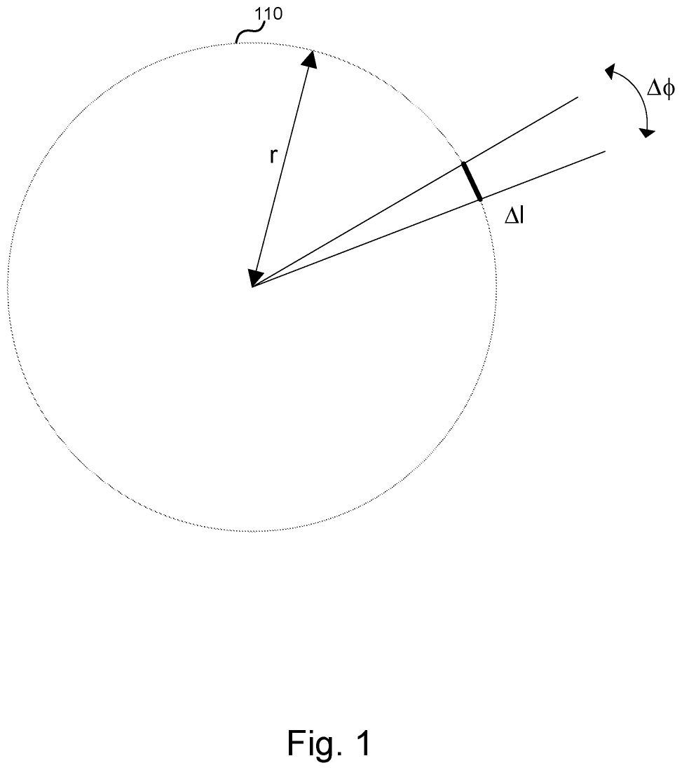

FIG. 1 illustrates computation of movement about the circumference of a circle 110, which can be equated to movement around the circumference of a pipe being scanned. The Y-axis distance about the circumference of a pipe may be derived based on the angle on the pipe as shown in FIG. 1. In this example,

Δl=Δϕ*r.

Where Δϕ is in radians.

The IMU may include a gyroscope and accelerometer, and some embodiments may further include a magnetometer. However, a magnetometer might not be used in working environments full of metal materials and in applications that use Eddy current devices on the probe as these can impact its performance. So, both gyroscope and accelerometer are generally used in embodiments to compute the distance along the Y-axis.

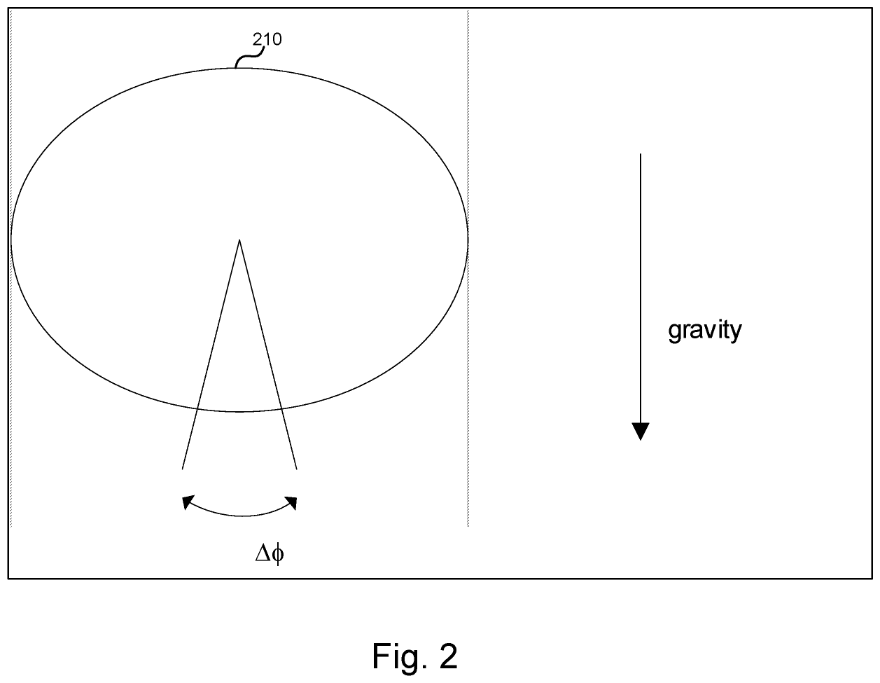

In a normal position (other than vertical position), the accelerometer can detect the rotation, then the Y-axis can be derived with the knowledge of pipe radius. The accelerometer may not function to detect rotation when it is in a vertical position, however, as illustrated in FIG. 2. Accelerometers alone can also be used to measure attitude (roll and pitch) but not yaw. If the pipe 210 is in a vertical position, the angle of yaw can't be detected by the accelerometer. In this case, the embodiments may rely on the gyroscope only.

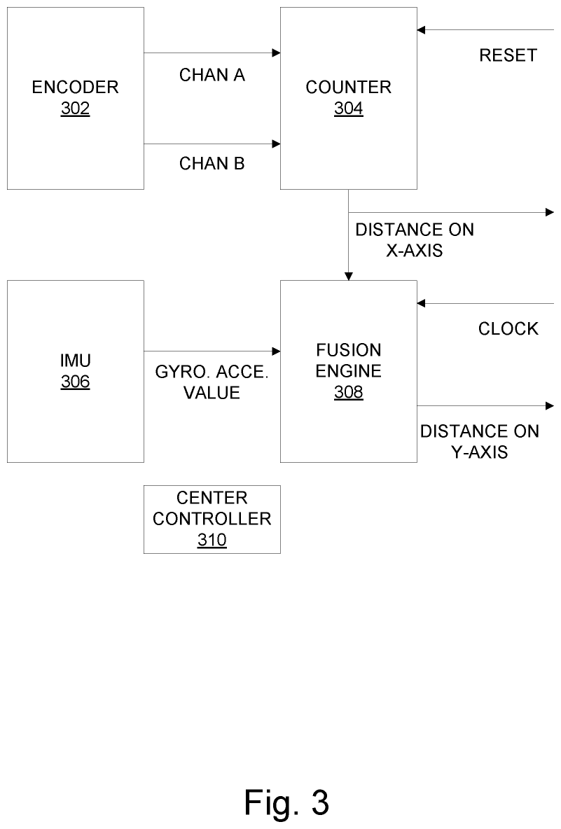

FIG. 3 is a diagram illustrating an example implementation of a probe including a mechanical encoder and an IMU with a Fusion engine in accordance with one embodiment. Particularly, this example includes an encoder 302, a counter 304, an IMU 306, and a Fusion engine 308. In addition, a central controller 310 can be included.

As discussed above, encoder 302 can be implemented as a mechanical encoder such as a rotary encoder or other like encoder using optical, magnetic or other rotational position detection techniques. The encoder 302 can be mounted directly or indirectly to an axle supporting wheels that rotate to allow of the probe to move along the X-axis. The encoder detects the rotation of the wheels by detecting markers (e.g., optical or magnetic markers) positioned about the axis (or other member connected to the axle such as via a gear or gear train). This information can be used to determine speed and direction of rotation of the axle which can be used to derive distance traveled by the scanner given the diameter of the wheels.

Counter 304 counts pulses from the encoder and uses this information to compute the distance. For example, each pulse-width indicates a given distance based on wheel diameter. Encoder 302 can be implemented as a quadrature encoder and the resolution of the encoder (e.g., the spacing of the markers) may vary depending on the accuracy required. In one embodiment, the encoder is implemented as an encoder having 12 steps per millimeter, although other resolutions may be chosen. Counter 304 can be reset (e.g., to zero) by a reset signal, which may be generated by the controller 310. For example, counter 304 may be reset at the beginning (or end) of each x-axis scan line. Counter 304 outputs a count, which can be sent to controller 310 or other circuit to determine the distance traveled along the X-axis. In some embodiments, Counter 304 may include circuitry to compute distance itself.

IMU 306 includes a 3-axis gyroscope and a 3-axis accelerometer in some embodiments. Values from the accelerometer (acceleration in the x, y and z directions) and gyroscope (rotation rate around its x, y, and z axis.) are provided to fusion circuit 308, the function of which is described in more detail below. In various embodiments, the encoder 302 and the IMU 306 may be calibrated to improve the accuracy and certainty of measurement.

Although not Illustrated, a clock can be provided to control timing of this circuit. For example, a 100 Hz clock can be used for simplicity, although other clock frequencies can be chosen as well. Because the probe is generally expected to move relatively slowly (by hand, or robotically), a 100 Hz clock may be sufficient for most applications and can accommodate 10 milliseconds sampling for reading of the X-axis and Y-axis distances. Faster clock speeds may be useful to accommodate more rapid movement of the probe or higher resolution measurement. For example, clock speeds of 100 Hz to 1 MHz may be implemented. Additionally, clock speeds of greater than 1 MHz may be implemented for rapidly moving probes or high-resolution measurements.

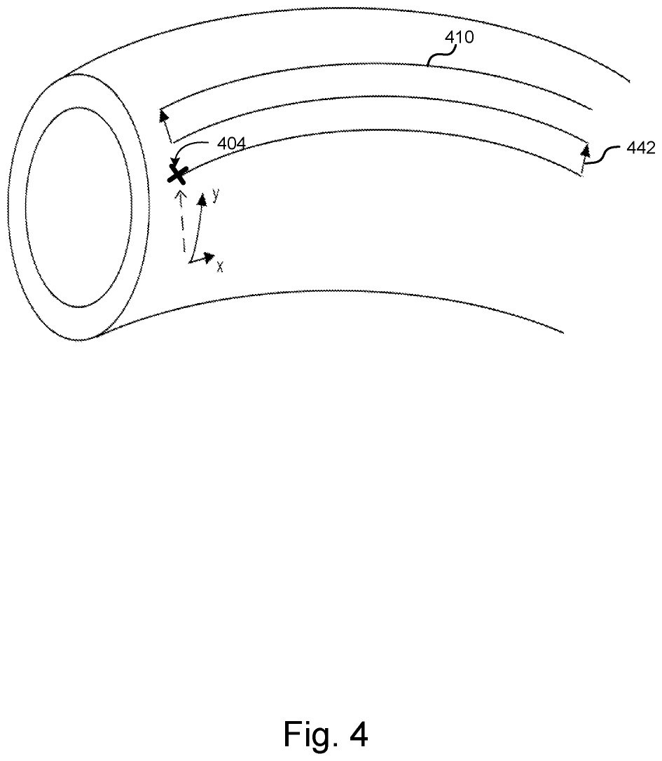

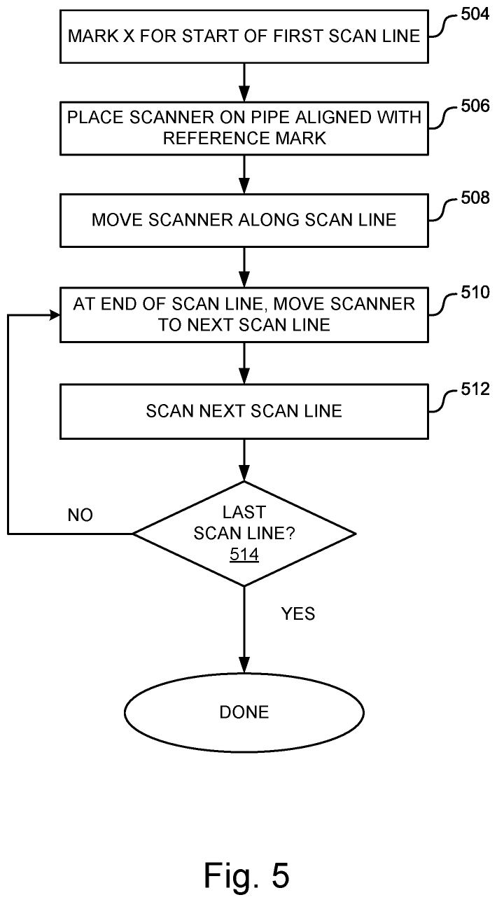

FIG. 4 illustrates an example of an operational scenario for a probe including an encoder and an IMU in accordance with various embodiments. FIG. 5 illustrate an example process for preparing the pipe for measurement and conducting the measurements in accordance with various embodiments. With reference now to FIGS. 4 and 5, at operation 504, a knife, marker, scoring tool, or other Implement is used to mark a reference point on the pipe. This is illustrated by the X 404 in FIG. 4. In various embodiments, X-axis scan lines need not be marked. This can apply, for example, to scanners that have wheels for mobility along the X-axis.

At operation 506, an operator or a robotic arm places the scanner on the reference point. In various embodiments, the scanner can include its own reference marking so that it can be properly lined up with the mark on the pipe.

Once the scanner is properly positioned, scanning can begin at operation 508 by moving the scanner along the axial direction (X-axis) from the marked X. The scanner may be moved manually by an operator, by a robotic arm or it may be self-propelled. In operation, care should be taken to ensure that the scanner moves along the scan line without significant deviation from an imaginary (or actually marked) scan line. Wheels at the bottom of the scanner can be used to not only ensure smooth motion along the X-Axis, but also to aid in ensuring that the motion is straight along the scan line. During movement along the X-axis, the encoder can be used to track the movement and the position of the scanner.

At the end of the scan line, the scanner is stopped and is moved from one scan line to another scan line (again, imaginary or marked) along the circumferential direction (along the Y-axis about the pipe). This is Illustrated at operation 510. Preferably, the scanner is moved to the very next scan line, although other scan patterns may be adopted. During movement along the Y-axis, the encoder can be used to track the movement and the position of the scanner about the circumference of the pipe to the next line to be scanned. In various embodiments, the scanner remains in contact with the pipe as it moves along the X & Y axes.

Once the scanner is moved to another scan line, the scanner can be moved along that scanline in the opposite direction. This is Illustrated at operation 510.

The next line is scanned along the X-axis in a manner similar to the first scan line as illustrated at operation 512. Operations 510 and 512 of moving to the next scan line and scanning along that line may be repeated until the last scan line is scanned as shown by decision step 514. As noted above, during movement in the Y direction, the IMU and the fusion algorithm can be used to track and record the motion of the scanner in the Y direction.

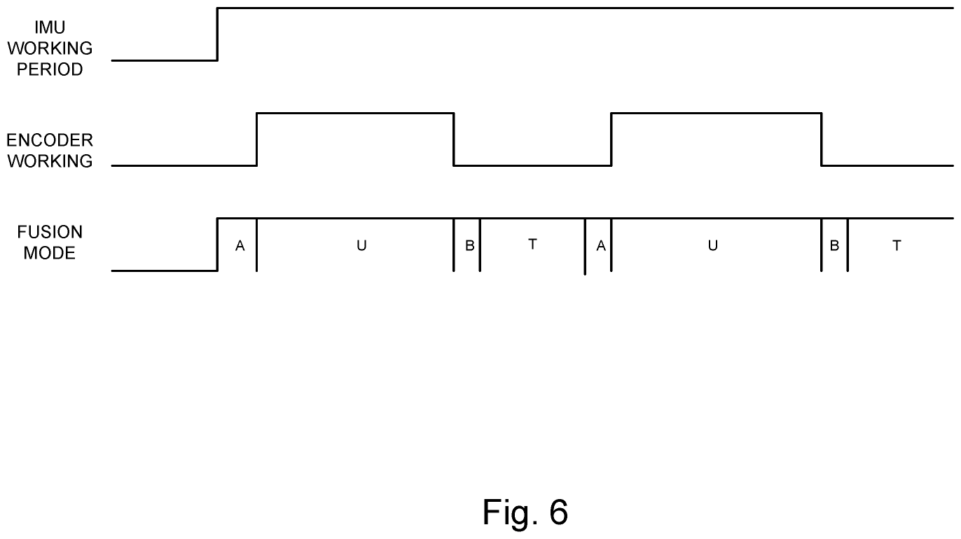

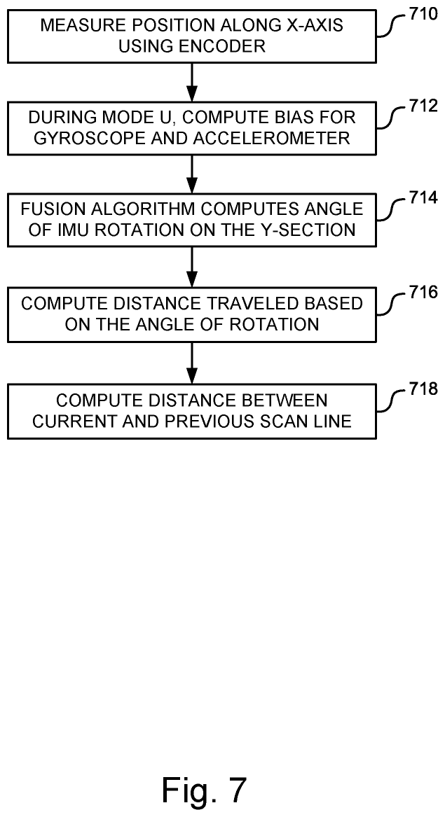

FIG. 6 illustrates a timing diagram for testing operations in accordance with one embodiment. FIG. 7 illustrates a process for position determination according to various embodiments. Referring now to FIGS. 6 and 7, this example defines four timing periods. Period A is the starting period before the scanner starts a scan line. During this period, the scanner is in a stationary position and scanning has not started along the x axis. Period U is the period during which the scanner is scanning along a scan line in the X-direction. During this period, as shown by operation 710, the encoder is measuring the distance/position along the X-axis. Period B is the period after the scanner finishes scanning a scan line and the scanner has stopped and is in a stationary situation. Period T is the period during which the scanner is moving on the Y-axis. During this period, the encoder should have no output (unless there is still some movement along the X-axis, which ideally there is not) and the IMU is operations. These four periods may be determined by the output from the IMU and the encoder.

Accordingly, the fusion algorithm may have 4 modes. During modes A and B, the fusion algorithm detects attitude of the scanner, estimates the noise of the gyroscope and acceleration from the accelerometer. During Period U the fusion algorithm computes bias for the gyroscope and accelerometer with input from the encoder and measurements in modes A, B or both. This is shown by operation 712. During Period T, at operation 714 the fusion algorithm computes the angle of rotation of the IMU along the Y-axis. An embodiment of this is described in more detail below with reference to FIG. 8. Using this information, at operation 716 the fusion algorithm computes the distance traveled by the scanner. This distance, from the initiation of Y-axis movement at the end of a given scan line until Y-axis movement halts at the position where X-axis scanning begins again is the distance traveled between two scan lines as shown at operation 718.

Travel distance measurements can be used to determine a position of the scanner during scanning operations. For example, scanner position can be determined based on distance and direction of travel from a prior known position. In various embodiments, a correlation circuit (not illustrated) may be included to determine position information based on distance measurements and to correlate this information with scans such that scan measurement data can be correlated to or tagged with position information. This can be included, for example, as part of controller 310, or it may be implemented using a separate processor (or other circuit) that receives distance information and scan data.

During periods A and B, based on output from IMU, noise can be estimated and used in the fusion circuit by the fusion algorithm. In the fusion algorithm, 3 accelerometer outputs (for 3 axes) and 1 gyroscope output (around x-axis) are used. During periods A and B, after removal of mean values, the covariance value of these 4 data streams can be computed as a covariance matrix of noise, and used in the algorithms.

During period B, calibration of the IMU can be performed. For the gyroscope, the IMU may be calibrated such that all the output from all axes are zero. For the accelerometer, the IMU may be calibrated such that the measured gravity should be 9.8 m/s², or a local gravity value, which could be a little bit different from 9.8 m/s²

During period B and before traversing the Y-axis section, the initial attitude of the IMU can be calculated. In one embodiment, this is done using the radius of the pipe being evaluated. The radius can be determined using known specifications for the pipe or it can be measured using conventional measurement techniques. The elevation angle, Ø, and the initial Y-section angle, θ₀, can be determined by accelerometer readings as follows.

$$\begin{matrix}{θ}_{0} = atan ( \frac{{a}_{0}}{{b}_{0}} ) & ( 1 ) \\ and & \\ ∅ = \frac{π}{2} - atan ( \frac{{c}_{0}}{\sqrt{{a}_{0}^{2} + {b}_{0}^{2}}} ) & ( 2 )\end{matrix}$$

where (a₀ b₀ c₀)^{T} is the accelerometer reading when the scanner (the IMU) is located at the end of the most recently measured X-section, which is the start of the Y-section. Because the probe will stay in this position for a period of time, the averaged value of (a₀ b₀ c₀)^{T} will improve computation accuracy in equations (1) and (2).

In mode T, the fusion algorithm is used to compute the angle of the IMU rotation on the Y-section. FIG. 8 illustrates an example of the geometry used to measure the angle of IMU rotation through the instant Y-section in one embodiment. Referring now to FIG. 8, the IMU has moved along the current X-section line on the pipe, which could be either a straight section of pipe or an elbow. Then, the IMU moves along the Y-section line between the instant X-section line and the next X-section line, which is on a circle perpendicular to the longitudinal axis of the pipe. The Y-section starts with rotation angle, θ₀. Rotation circle has radius of r and an elevation angle, Ø, from the horizontal plane.

The IMU is mounted on the scanner such that its X-axis is aligned with the Y-section, its Z-axis is aligned with the X-section and its Y-axis is pointed to the center of the rotation circle as shown in this example.

If the rotation angle θ is 0, the normalized acceleration reading (divided by gravity, g, or 9.8 m/s²) from 3 axis of accelerometer will be:

a₀=(0,sin Ø,cos Ø)^{T} (3)

The IMU is moving on along the circle with an axis of:

c=(cₓ,c_{y},c_{z})^{T}=(0,0,1)^{T} (4)

Where c is a 3×3 unit vector. After the IMU rotates by an angle θ counterclockwise, the normalized reading from the accelerometer is:

a_{θ}=Ra₀ (5)

Where R is the 3×3 rotation matrix, a₀, a_{θ} and are both 3×1 vectors.

By Rodrigues rotation formula, R is

R=I+sin θC+(1−cos θ)C² (6)

Where I is a 3×3 identity matrix, and C is a 3×3 cross-product matrix for the unit vector c, given by:

$$C = [ \begin{matrix}0 & - {c}_{z} & {c}_{y} \\ {c}_{z} & 0 & - {c}_{x} \\ - {c}_{y} & {c}_{x} & 0\end{matrix} ] \qquad ( 7 )$$

Note that the IMU rotates through an angle θ counterclockwise, equivalent to the gravity vector, which rotates through an angle θ clockwise in IMU frame. Therefore,

$$\begin{matrix}{a}_{θ} = {h}_{∅} ( - θ ) & ( 8 ) \\ {h}_{∅} ( - θ ) = [ \begin{matrix}cos θ & sin θ & 0 \\ - sin θ & cos θ & 0 \\ 0 & 0 & 1\end{matrix} ] {a}_{0} = [ \begin{matrix}sin θsin∅ \\ cos θsin∅ \\ cos ∅\end{matrix} ] & ( 9 )\end{matrix}$$

In terms of a state-space description of the system, state vector (3×1) in an embodiment of the fusion algorithm is set forth as:

x=(θ,ω,\dot{ω})^{T} (10)

Where \dot{ω} is the change of the rate of angular speed along the same direction of ω.

The transformation matrix would be:

$$A = [ \begin{matrix}1 & dt & 0.5 {dt}^{2} \\ 0 & 1 & dt \\ 0 & 0 & 1\end{matrix} ] \qquad ( 11 )$$

When the IMU moves on the pipe, accelerometer readings are also affected by centripetal acceleration and tangential acceleration. Centripetal force is the force that acts on the IMU moving in a circular path and is directed toward the center around which the IMU is moving. The centripetal acceleration associated with centripetal force is always orthogonal to the motion of the object and towards the fixed point of the instantaneous center of curvature of the path.

If the object is moving with instant angular velocity, ω, on the circular path with radius, r, then the value of centripetal acceleration is:

a_{c}=v²/r=ω²r (12)

where, v, is the instant tangential linear velocity. This centripetal force/acceleration exists even the object has constant angular speed ω. And if the angular speed is not constant, there will be another acceleration, namely tangential linear acceleration. This acceleration is always towards the instantaneous direction of the object's movement and is given by:

$${a}_{t} = \frac{r Δω}{Δ t} = \dot{ω} r \qquad ( 13 )$$

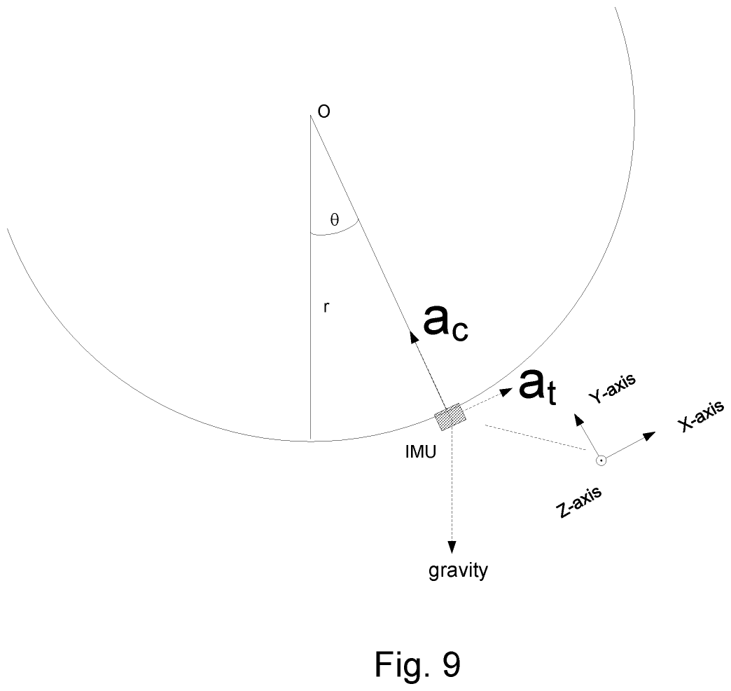

FIG. 9 illustrates centripetal acceleration and tangential acceleration. To improve the accuracy of the angular measurement, state-space representations with those accelerations may be used in some embodiments.

Measurement equations are given by:

$$\begin{matrix}{\tilde{w}}_{x , k} = {ω}_{k} + {n}_{e , ω} & ( 14 ) \\ {\tilde{a}}_{k} = {h}_{∅} ( {θ}_{k} ) + [ \begin{matrix}- \dot{ω} r \\ {ω}^{2} r \\ 0\end{matrix} ] + {n}_{e , a} & ( 15 )\end{matrix}$$

where, r is the radius of pipe, \tilde{w}_{x,k} is a scale value of gyroscope reading for rotation about the X-axis, ãₖ is 3×1 vector for accelerator reading (after normalization, i.e. divided by gravity) on the X-axis, Y-axis and Z-axis. Note that the centripetal acceleration equals ω²r, applied on the Y-axis, while the tangential acceleration is −\dot{ω}r, applied on the X-axis of the accelerometer. n_{e,ω} and n_{e,a} are measuring noise of the gyroscope output on the X-axis and the accelerometer output on the 3 axes, respectively. The noise in this example includes IMU built-in noise and the noise due to vibration of the probe (with the IMU) when moving along the pipe. Equation 15 also uses the known radius of the pipe.

Multiple methods may be used in solving state-space equations. These include Extended Kalman Filter (EKF) and Unscented Kalman Filter (UKF). Coarse calibration of the IMU and fine calibration of the gyroscope can also improve performance.

To address an operational scenario in which the pipe is oriented vertically, the fusion algorithm may place greater weight on gyroscope data than it places on the accelerometer data (e.g., by setting noise covariance matrix in EKF or UKF). The calibration of the gyroscope may be important to fusion accuracy. After the coarse calibration, further fine calibration may be used.

In fine calibration stage, two parameters of the gyroscope may be calibrated. These are the scale factor and the DC bias. Because only the gyroscope readings on X-axis are used, the process calibrates these two parameters on X-axis reading.

FIG. 1010. The method of claim 9, The rights granted i include the right of Licensee to have such rights exercised by a third party on behalf of Licensee. illustrates the impact of DC bias and scale factor error. As shown in this figure, the scale factor and the DC bias have different behavior affecting the results. In FIG. 9, the X-axis is time, and Y-axis is the rotation angle as computed by integrating the gyroscope output over the Y-axis rotation. As illustrated by the dashed line in the figure, the DC bias 911 affects test results in all time periods, including the IMU stationary period and the IMU rotation period. The error in scale factor 912 affects rotation angle only during the rotation period as illustrated by the dotted line.

To improve performance, the residual DC bias can be estimated by computing the mean of the output of the gyroscope in the stationary period, and then this bias may be removed in the rotation stage. The scale factor can be further calibrated as:

new_scale_factor=old_scale_factor*angle_true/(angle_true+angle_err)

where angle_true and angle_err are defined in FIG. 9.

The fine calibration of the scale factor may be performed off-line periodically (e.g., once every several months), which may be the same period as coarse calibration. The fine calibration of the DC bias can be performed off-line and at a stationary period when the IMU is in the field.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. In other words, as would be apparent to one of ordinary skill in the art after reading this description, the various features and functionality described herein may be implemented in any given application and can be implemented in one or more separate or shared circuits in various combinations and permutations. Even though various features or elements of functionality may be individually described or claimed as separate circuits, one of ordinary skill in the art will understand that these features and functionality can be shared among one or more common circuits, and such description shall not require or imply that separate circuits are required to implement such features or functionality.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A positioning device for a scanner, comprising:
an encoder to detect movement the scanner along scan lines parallel to a first axis of an object being scanned;
a counter configured to count encoder pulses from the encoder and configured to compute distance traveled by the scanner along a first scan line;
an inertial measurement unit comprising a 3-axis accelerometer and a gyroscope; and
a fusion circuit configured receive acceleration and angular velocity from the 3-axis accelerometer and gyroscope, respectively, use the received acceleration and angular velocity to compute an angle of rotation of the scanner along a second axis of the object being scanned that is perpendicular to the first axis, and to use the computed angle of rotation to determine a distance traveled along the second axis between first and second scan lines.

2. The positioning device of claim 1, wherein the encoder is an optical or magnetic encoder.

3. The positioning device of claim 1, further comprising a processor to correlate scanner position measured using information from the counter and the fusion circuit with scan data obtained by the scanner during scanning.

4. The positioning device of claim 3, wherein the scanner is operated and scan data correlated to the measured position without requiring that scan lines be marked on a section of a pipe being scanned by the scanner.

5. The positioning device of claim 3, wherein the processor is part of the fusion circuit or is communicatively coupled to the fusion circuit.

6. The positioning device of claim 1, further comprising a processor determining a position of the device using the distance traveled measurements from the counter and the fusion circuit.

7. The positioning device of claim 1, wherein computing the angle of rotation comprises removing the mean values from the acceleration and angular velocity measurements and computing a covariance value of acceleration and angular velocity data.

8. The positioning device of claim 7, further comprising estimating noise and wherein computing a covariance value comprises computing a covariance value of acceleration and angular velocity data as a covariance matrix of noise.

9. (canceled)

10. (canceled)

11. (canceled)

12. (canceled)

13. (canceled)

14. A method for determining positioning of a scanner moving along a section of a pipe, comprising:
an encoder and a counter measuring distance traveled by the scanner along a plurality of scan lines along a length of the section of the pipe;
measuring acceleration and angular velocity of the scanner around a portion of the circumference of the pipe between successive scan lines;
computing an angle of rotation of the scanner around the portion of the circumference of the pipe between successive scan lines, and
and determining a distance traveled around the portion of the circumference of the pipe between first and second scan lines using the computed angle of rotation.

15. The method of claim 14, wherein computing the angle of rotation comprises removing the mean values from the acceleration and angular velocity measurements and computing a covariance value of acceleration and angular velocity data.

16. The method of claim 15, further comprising estimating noise and wherein computing a covariance value comprises computing a covariance value of acceleration and angular velocity data as a covariance matrix of noise.

17. (canceled)

18. The method of claim 14, further comprising determining a position of the device using the distance traveled measurements from the counter and the fusion circuit.

19. (canceled)

20. (canceled)

21. (canceled)

22. (canceled)

23. (canceled)

24. A positioning device for a scanner, comprising:
means for detecting movement the scanner along scan lines parallel to a first axis of an object being scanned;
means for counting encoder pulses from the encoder and configured to compute distance traveled by the scanner along a first scan line;
means for measuring acceleration and angular velocity of the scanner; and
means for computing an angle of rotation of the scanner along a second axis of the object being scanned that is perpendicular to the first axis using the received acceleration and angular velocity, and for determining a distance traveled along the second axis between first and second scan lines using the computed angle of rotation.

25. The positioning device of claim 24, wherein the means for detecting movement comprises an optical or magnetic encoder.

26. The positioning device of claim 24, further comprising determining a position of the device using the distance traveled measurements from the counter and the fusion circuit.

27. The positioning device of claim 24, further comprising a means for correlating scanner position measured by the encoder and the fusion circuit with scan data obtained by the scanner during scanning.

28. The positioning device of claim 27, wherein the scanner is operated and scan data correlated to the measured position without requiring that scan lines be marked on a section of a pipe being scanned by the scanner.
